(19) United States
(12) Patent Application Publication
(10) Pub. No.: US 2008/0119323 A1
(43) Pub. Date: May 22, 2008

(54) Control device for vehicle automatic transmission

(75) Inventor: Ichiro Kitaori, Nagoya-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 11/984,521

(22) Filed: Nov. 19, 2007

(30) Foreign Application Priority Data
Nov. 17, 2006 (JP) 2006-312160

(51) Int. Cl. F16H 59/60

(52) U.S. Cl. 477/97

(57) ABSTRACT

The present invention intends to provide a control device for controlling a vehicle automatic transmission which can prevents a feeling of sudden starting of a vehicle, even if a special mode running control prohibiting a shifting to a shifting position less than a predetermined shifting position is started during a fixed gear ratio running control fixing a gear ratio of the automatic transmission. For the above purpose, when control by special mode running control means (106) is executed during control by fixed gear ratio running control means (104), the special mode running control to be executed by a special mode set switch (114) operated by a driver is exclusively preferentially executed over the fixed gear ratio running control. Thus, occurrence of the vehicle sudden starting responsive to the accelerator operation can be suitably suppressed.

### TECHNICAL FIELD

The present invention relates to a control device for a vehicle automatic transmission, and more particularly, it relates to the control device for controlling the vehicle automatic transmission having both a fixed gear ratio running control means and a special mode running control means.

### BACKGROUND ART

There are vehicles in which so-called traction control (TRC) is executed in which, when a slip ratio of driving wheels with respect to a road surface exceeds a predetermined value, a drive force of the driving wheels is controlled so that the slip ratio is approximated to a target slip ratio. In such vehicles, a driving wheel speed is used in place of a vehicle speed as a basis for shifting determination in the shifting control for the automatic transmissions thereof in some cases. In accordance therewith, a vehicle speed sensor can be omitted or is made redundant, but the following problem will occur. That is, the driving wheel speed suddenly changes due to the driving wheels slipping during control execution of the traction control in some cases. As a result of shifting determination based on such a sudden change in the driving wheel speed, unnecessary or unwanted shifting occurs, which gives passengers a shifting shock by shift hunting.

In order to solve such problem, in Patent Document 1 (Japanese Published Unexamined Patent Application No. 5-112162), there is disclosed a technology of suppressing an occurrence of unwanted shifting in execution of the traction control by allowing a change in shifting positions by shifting control of the automatic transmission only when the shifting determination continues over a predetermined time period.

Meanwhile, in some cases, in place of or in addition to the traction control, fixed gear ratio running control which fixes a shifting position of the automatic transmission to a 1st gear ratio which is relatively high is executed. Extremely low-speed running control which is one example of the fixed gear ratio running control is executed when the vehicle runs on a rough road such as a rocky road. The vehicle is driven or runs by controlling a throttle opening and brakes of the respective wheels so that a vehicle speed follows a target vehicle speed which is an extremely low-speed set by a driver, while a shifting position of the automatic transmission is fixed to a gear ratio at a minimum speed side such as a 1st shifting position or 1st speed position.

On the other hand, in a vehicle, in some cases, a shifting different from the normal shifting is performed for the automatic transmission by switching a mode to a special mode. That is, for example, special mode running control which prohibits the shifting from a second gear ratio set to a value less than the first gear ratio to a lower-speed side. Snow mode control which is one example of the special mode running control is executed, for example, when the vehicle runs on a low-μ (frictional coefficient) road such as a compacted snow road or an icy road. In order for the driving wheels to be prevented from slipping when the vehicle starts and runs with suppressed driving torque of driving wheels, the automatic transmission is prohibited from shifting to a gear ratio higher than the predetermined second gear ratio.

Here, because the fixed gear ratio running control and the special mode running control are executed independently or separately, there is the problem that, when the special mode running control is selected during control execution of the fixed gear ratio running, a feeling of sudden acceleration or sudden starting of the vehicle is caused. For example, because the shifting control by the extremely low-speed running control and that by the snow mode control are respectively independent, control execution by the shifting control by the snow mode during control execution of the extremely low-speed running control is possible.

In this way, when the snow mode control is executed during the extremely low-speed running control, the both controls are executed redundantly. Required shifting position of the automatic transmission in the extremely low-speed running control and that of the snow mode control are different from one another. A predetermined shifting position of the automatic transmission fixed by the extremely low-speed running control corresponds to a shifting position of the same prohibited from being used by the snow mode control. However, the shifting position of the automatic transmission can be controlled by only one of the both controls. Accordingly, by controlling a shifting position of the automatic transmission on the basis of one of the both controls, other shifting position different from the shifting position is set by the other control, which causes the problem that the premise of the other control cannot be obtained.

As a result, for example, when a shifting position of the automatic transmission is set in a shifting position higher than a shifting position predetermined by the other control newly executed, that is, a shifting position at a lower-speed side, when a driver performs an accelerator operation in the same way as that before changing the shifting position, there may be caused an unintended or unexpected feeling of sudden starting of the vehicle.

### SUMMARY OF THE INVENTION

The present invention has been achieved in consideration of the above-described circumstances, and has an object to provide a control device for controlling a vehicle automatic transmission which does not suffer from a feeling of sudden starting of a vehicle, even if the special mode running control is selected during the fixed gear ratio running control which fixes a gear ratio of the automatic transmission.

In order to achieve the above object, the present invention is featured by that a control device for controlling a vehicle automatic transmission, comprising: (i) fixed gear ratio running control means or a fixed gear ratio running control portion that fixes a gear ratio of the automatic transmission in a first gear ratio; and (ii) special mode running control means or a special mode running control portion that prohibits shifting to a lower vehicle speed side from a second gear ratio set in a value less than the first gear ratio, (iii) wherein when a special mode running control is selected during execution of a fixed gear ratio running control, the special mode running control is exclusively preferentially executed.

In accordance therewith, when the control by the special mode running control means is executed during control execution by the fixed gear ratio running control means, the, control by the special mode running control means is exclusively executed in preference to the control by the fixed gear ratio running control means. As a result, a feeling of sudden starting of the vehicle can be prevented.

Preferably, the fixed gear ratio running control means is extremely low-speed running control means or an extremely low-speed running control portion that controls a drive force and a brake force of driving wheels so that an actual vehicle speed reaches an extremely low-speed target vehicle speed set in advance, and fixes the gear ratio of the automatic transmission in a gear ratio set at a maximum side.

In accordance therewith, the fixed gear ratio running control means fixes the gear ratio of the automatic transmission in one that is set at the maximum side, that is, the gear ratio at the lowest-speed side during the extremely low-speed running. Accordingly, a drive force of the driving wheels suitable for a vehicle speed that reaches a target vehicle speed which is an extremely low speed set in advance, can be obtained.

Preferably, the special mode running control means is snow mode control means or a snow mode control portion which is selected based on an operation of a snow mode switch, and which sets the gear ratio in the value less than the first gear ratio of the automatic transmission.

In accordance therewith, the snow mode control means prohibits the automatic transmission from being set to the predetermined first gear ratio which is a high gear ratio. Accordingly, when the control by the special mode running control means is executed during control execution by the fixed gear ratio running control means, the special mode running control means is given preference thereover, and the fixed gear ratio running control means does not set a higher gear ratio hereinafter. Thus, the feeling of sudden staring of the vehicle unexpected by the driver can be avoided.

Preferably, the control device is further comprised of (i) snow mode determination means or a snow mode determination portion that determines whether or not a running mode set by a driver is a snow mode, and (ii) fixed gear ratio running determining means or a fixed gear ratio running determination portion that determines whether or not fixed gear ratio running control is executed, (iii) wherein when the snow mode is not determined by the snow mode determining means, and execution of fixed gear ratio running is determined by the fixed gear ratio running determining means, the fixed gear ratio running control means starts fixing of the gear ratio of the automatic transmission in the first gear ratio.

In accordance therewith, the driver's intension to perform control by the snow mode control means and control by the fixed gear ratio running control means by the snow mode determining means and the fixed gear ratio running determining means can be respectively determined. When the snow mode is not determined by the snow mode determining means, and execution of the fixed gear ratio running is determined by the fixed gear ratio running determining means, the fixed gear ratio running control means starts fixing of the gear ratio of the automatic transmission in the first gear ratio by the fixed gear ratio. As a result, the snow mode control means is exclusively executed preferentially.

Preferably, when the snow mode determining means determines the snow mode, the fixing of the gear ratio of the automatic transmission to the first gear ratio by the fixed gear ratio running control means is completed.

In accordance therewith, when the snow mode determining means determines the snow mode during control execution by the fixed gear ratio running control means, the control execution by the fixed gear ratio running control means is interrupted. Accordingly, the control by the snow mode control means is exclusively executed in preference to the control by the fixed gear ratio running control means.

Preferably, the automatic transmission is a step variable automatic transmission having a plurality of forward shifting positions, and when the snow mode determining means determines the snow mode, the snow mode control means prohibits the shifting to a shifting position at a minimum vehicle speed side among the plurality of forward shifting positions of the automatic transmission.

In accordance therewith, during control execution by the snow mode control means, the use of the shifting position at the minimum vehicle speed side among the shifting positions of the automatic transmission is prohibited. As a result, there is no case where starting and running is executed by use of the shifting position at a high gear ratio, thereby preventing the driving wheels of the vehicle from slipping upon starting and running on a low-μ road or the like.

Preferably, the fixed gear ratio running control means fixes the shifting position of the automatic transmission in the shifting position at the minimum vehicle speed side among the plurality of forward shifting positions of the automatic transmission.

In accordance therewith, because the shifting position of the automatic transmission is fixed in one that is at the minimum vehicle speed side, that is, the shifting position at a high gear ratio. Thus, the drive force is ensured.

More preferably, the control device for a vehicle automatic transmission includes a fixed gear ratio running control means, an extremely low-speed running control means and an extremely low-speed running control switch to execute the extremely low-speed running control means. The extremely low-speed running control means is composed of a target vehicle speed following means that controls a throttle and brakes of the respective wheels so that a vehicle speed follows the target vehicle speed which is an extremely low-speed of about 1 km/h to 5 km/h.

In accordance therewith, the shifting position of the automatic transmission is fixed in a predetermined shifting position by the fixed gear ratio running control means, and the throttle and the brakes of the respective wheels are controlled by the target vehicle speed following means so that the vehicle speed follows the target vehicle speed which is the extremely low-speed. Accordingly, the vehicle can run to follow the target vehicle speed which is the extremely low-speed. Further, when the extremely low-speed running control switch is operated by the driver, the extremely low-speed running control means executes its control.

### BRIEF DESCRIPTION OF THE DRAWINGS

FIG. 1 is a view showing essential parts of a vehicle automatic transmission to which the present invention is preferably applied;

FIG. 2 is a diagram for describing engagement and release states of clutches and brakes for establishing respective gear positions of the automatic transmission shown in FIG. 1;

FIG. 3 is a diagram for describing input-output signals of an electronic control device provided to a vehicle of an embodiment shown in FIG. 1;

FIG. 4 is a perspective view concretely showing a shift lever shown in FIG. 3;

FIG. 5 is a diagram showing one example of a relationship between an accelerator opening Acc and a throttle valve opening θ_{TH} used for throttle control executed by the electronic control device shown in FIG. 3;

FIG. 6 is a diagram showing one example of a shifting diagram (map) used for a shifting control of an automatic transmission executed by the electronic control device shown in FIG. 3;

FIG. 7 is a functional block diagram for describing principal parts of control functions by the electronic control device shown in FIG. 3;

FIG. 8 is a view showing one example of a special mode switch shown in FIG. 7;

FIG. 9 is a view showing one example of an extremely low-speed running control set switch shown in FIG. 7;

FIG. 10 is a flowchart for describing principal parts of the control functions of the electronic control device in FIG. 3, that is, operations of the control device for an automatic transmission provided to the vehicle; and

FIG. 11 is a set of time charts for describing contents of extremely low-speed running control.

### BEST MODE FOR CARRYING OUT THE INVENTION

Hereinafter, one embodiment of the present invention will be described in detail with reference to the drawings.

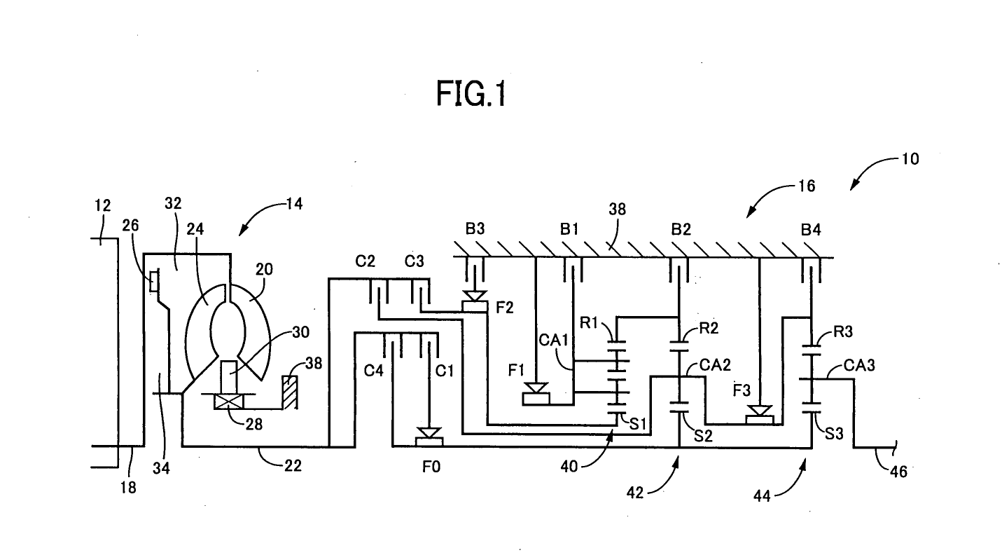

FIG. 1 is a view showing essential parts for describing a structure of a vehicle power transmission device 10 to which the present invention is applied. In FIG. 1, an output of an engine 12 serving as a drive force source for running composed of, for example, an internal combustion is inputted to a step variable automatic transmission 16 via a torque converter 14 serving as a hydraulic power transmitting device. Thereafter, the output is transmitted to driving wheels via a differential gear unit and axles (not shown).

The torque converter 14 includes a pump wheel 20 coupled to the engine 12, a turbine wheel 24 coupled to an input shaft 22 of the automatic transmission 16, and a stator vane 30 whose rotation in one direction is stopped by a one-way clutch 28. The torque converter 14 includes a lockup clutch 26 to execute power transmission via a fluid existed between the pump wheel 20 and the turbine wheel 24, and to connect both of them directly.

The lockup clutch 26 is a hydraulically operated friction clutch to be frictionally engaged by a differential pressure ΔP between an oil pressure inside an engagement side oil chamber 32 and an oil pressure inside a release side oil chamber 34. The pump wheel 20 and the turbine wheel 24 are integrally rotated due to the complete engagement by the lockup clutch 26. Further, due to a differential pressure ΔP, that is, an engagement torque being feedback-controlled so as to have engagement in a predetermined slip state, during a time a vehicle is being driven (powered on), the turbine wheel 24 is rotated to follow the pump wheel 20 by a predetermined slip ratio of, for example, about 50 rpm, that is, is slipping-engaged. On the other hand, during a time the vehicle is not being driven (powered off), the pump wheel 20 is rotated to follow the turbine wheel 24 by a predetermined slip ratio of, for example, about −50 rpm.

The automatic transmission 16 is a planetary gear type transmission including a double pinion type first planetary gear drive 40, and single pinion type second planetary gear drive 42 and third planetary gear drive 44. A sun gear S1 of the first planetary gear drive 40 is selectively coupled to the input shaft 22 via a clutch C3, and is further selectively coupled to a housing 38 via a one-way clutch F2 and a brake B3 to be stopped to rotate in an opposite direction (a direction opposite to the input shaft 22).

A carrier CA1 of the first planetary gear drive 40 is selectively coupled to the housing 38 via a brake B1, and is further always stopped to rotate in the opposite direction by a one-way clutch F1 provided parallel with the brake 1. A ring gear R1 of the first planetary gear drive 40 is integrally coupled to a ring gear R2 of the second planetary gear drive 42, and is selectively coupled to the housing 38 via a brake B2.

A sun gear S2 of the second planetary gear drive 42 is integrally coupled to a sun gear S3 of the third planetary gear drive 44. The sun gear S2 is selectively coupled to the input shaft 22 via a clutch C4, and is further selectively coupled to the input shaft 22 via a one-way clutch F0 and a clutch C1, and is stopped to rotate in a direction relatively opposite to the input shaft 22. A carrier CA2 of the second planetary gear drive 42 is integrally coupled to a ring gear R3 of the third planetary gear drive 44. The carrier CA2 is selectively coupled to the input shaft 22 via a clutch C2, and is selectively coupled to the housing 38 via a brake B4. Moreover, the carrier CA2 is always stopped to rotate in the opposite direction by a one-way clutch F3 provided parallel with the brake B4.

A carrier CA3 of the third planetary gear drive 44 is integrally coupled to an output shaft 46. Torque outputted from the output shaft 46 is transmitted to the driving wheels via a propeller shaft and differential gear unit (not shown), or is transmitted to the front and rear driving wheels via a transfer device and front and rear differential gear units. In accordance therewith, running of the vehicle is realized.

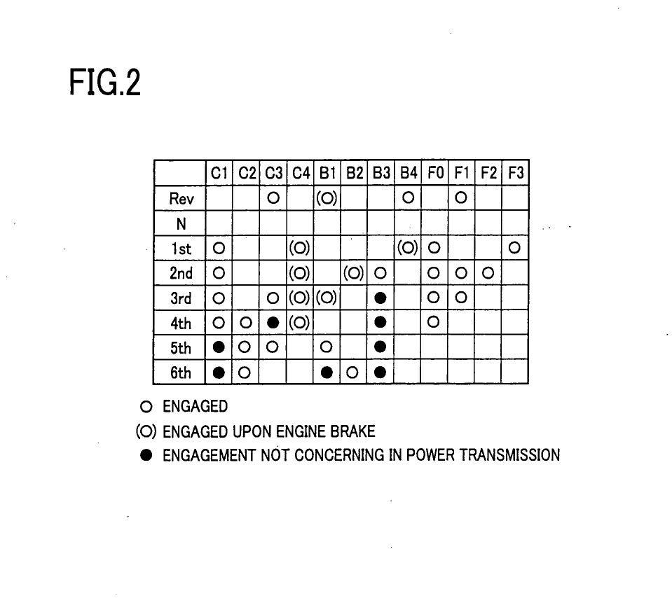

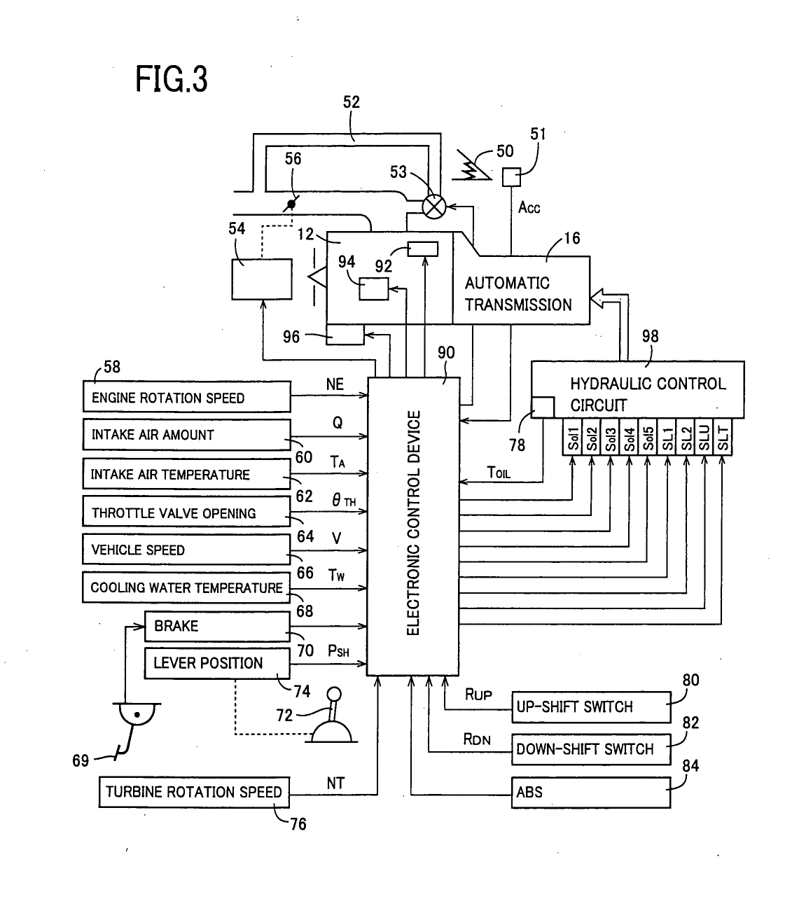

The above-described clutches C1 to C4, and the brakes B1 to B4 (hereinafter simply called the “clutches C” and the “brakes B” with no particular distinction) are hydraulically operated frictional engaging devices such as multiple-disc clutches and brakes, which are controlled to be engaged by a hydraulic actuator. A hydraulic circuit is switched by excitation or non-excitation of solenoid-operated valves Sol1 to Sol5 and linear solenoid-operated valves SL1 and SL2 of a hydraulic control circuit 98 which will be described next (refer to FIG. 3), or manual valves (show shown). In accordance therewith, the clutches C and the brakes B are switched between the engagement and release states, for example, as shown in FIG. 2.

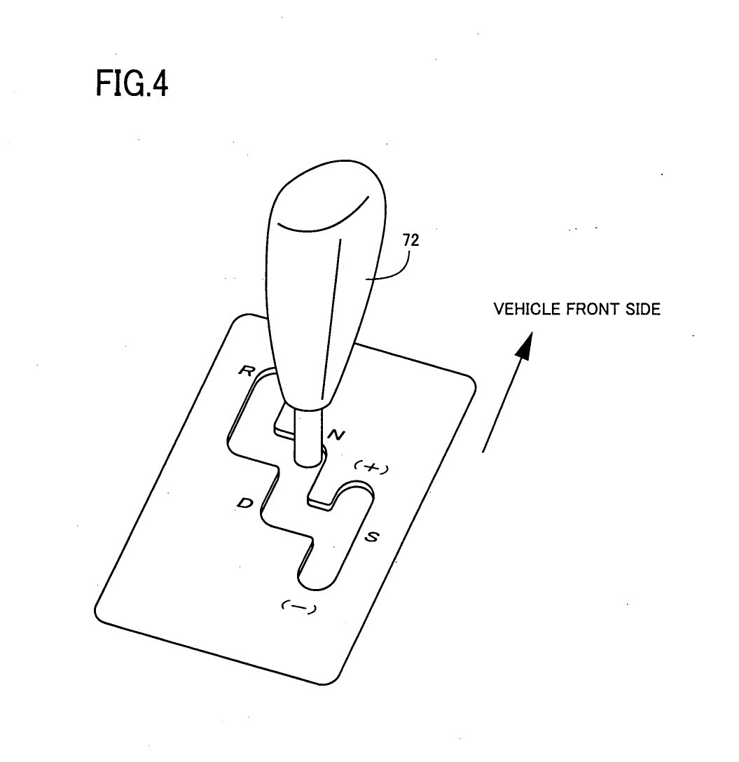

In FIG. 2, “∘” denotes engagement, and a blank column denotes release, “(∘)” denotes engagement during engine braking, and “” denotes engagement concerned in power transmission. Six forward shifting positions (1st to 6th) and one reverse shifting position (Rev) are established in accordance with an operative position (position) of a shift lever 72 (refer to FIG. 4). The “1st” to “6th” denote the 1st shifting position to 6-th shifting position for forward running, and a gear ratio γ (a rotational speed NIN of the input shaft 22/a rotational speed NOUT of the output shaft 46) is made less as it goes from the 1st shifting position “1st” to the 6-th shifting position “6th.” A gear ratio of the 4-th shifting position “4th” is selected to be 1.0.

FIG. 3 is a block diagram for describing a control system provided to the vehicle in order to control the engine 12, the automatic transmission 16, and the like in FIG. 1. The hydraulic control circuit 98 in FIG. 3 includes the above-described solenoid-operated valves Sol1 to Sol5 and the linear solenoid-operated valves SL1 and SL2 for shifting. In addition thereto, there are provided a linear solenoid-operated valve SLU to mainly control a differential pressure ΔP between a lockup oil pressure, that is, an oil pressure inside the engagement side oil chamber 32 and an oil pressure inside the release side oil chamber 34, and a linear solenoid-operated valve SLT to mainly control a line oil pressure. An operating oil inside the hydraulic control circuit 98 is supplied to the lockup clutch 26 as well, and is used for lubricating the respective parts of the automatic transmission 16 and the like.

An accelerator opening Acc which is an operated (depressed) amount of an accelerator pedal 50 is detected by an accelerator opening sensor 51. The accelerator pedal 50 is largely depressed in accordance with an extent of output request from a driver, and corresponds to an accelerator operation member of the invention. An accelerator opening Acc corresponds to the extent of output request of the invention.

To an air intake piping of the engine 12, an electronic throttle valve 56 set to an opening angle corresponding to an accelerator opening Acc, that is, a throttle opening θ_{TH} by a throttle actuator 54 is provided. Further, to a bypass path 52 which bypasses the electronic throttle valve 56 for an idling rotation speed control, an ISC (idling rotation speed control) valve 53 is provided to control intake air amount when the electronic throttle valve 56 is fully closed to control an idling speed NEIDL of the engine 12.

In addition thereto, an engine rotation speed sensor 58 to detect a rotation speed NE of the engine 12, an intake air amount sensor 60 to detect amount Q of intake air of the engine 12, and an intake air temperature sensor 62 to detect a temperature TA of intake air are provided. Further, a throttle valve sensor 64 with an idling switch to detect a fully-closed state (idle state) of the electronic throttle valve 56 and a throttle opening θ_{TH} thereof, a vehicle speed sensor 66 to detect a vehicle speed V (corresponding to a rotation speed NOUT of the output shaft 46), a cooling water temperature sensor 68 to detect a cooling water temperature TW of the engine 12, and a brake switch 70 to detect an operation of a foot brake pedal 69 serving as a service brake are provided.

Moreover, a lever position sensor 74 to detect a lever position (an operative position) PSH of the shift lever 72, a turbine rotation speed sensor 76 to detect a turbine rotation speed NT (equivalent to a rotation speed NIN of the input shaft 22), an AT oil temperature sensor 78 to detect an AT oil temperature TOIL which is a temperature of an operating oil inside the hydraulic control circuit 98, a shift-up switch 80, a shift-down switch 82, and the like are provided.

Signals indicating an engine rotation speed NE, an intake air amount Q, an intake air temperature TA, a throttle opening θ_{TH}, a vehicle speed V, an engine cooling water temperature TW, the presence or absence of an operation of the brake, a lever position PSH of the shift lever 72, a turbine rotation speed NT, an AT oil temperature TOIL, an shifting range-up command RUP and shifting range-down command RDN are supplied to the electronic control device 90 from those sensors and switches.

Further, the electronic control device 90 is connected to an ABS (Antilock Brake System) 84 to control a brake force to prevent the wheels from being locked (slipping) upon operating the foot brake pedal 69, and information on brake oil pressure corresponding to the brake force are supplied thereto.

The electronic control device 90 is composed of a so-called microcomputer having a CPU, a RAM, a ROM, input-output interfaces, and the like. The CPU is constructed to execute output control of the engine 12, shifting control of the automatic transmission 16, lockup clutch control of the lockup clutch 26, and the like by performing signal processing in accordance with a program stored in advance in the ROM while utilizing a temporary storage function of the RAM. The CPU is structured to be separated to a portion for engine control and a portion for shifting control as needed.

To describe the output control of the engine 12, the electronic throttle valve 56 is controlled to be opened and closed by the throttle actuator 54. In addition thereto, a fuel injection valve 92 is controlled to control a fuel injection amount, an ignition system 94 such as an igniter is controlled to control an ignition timing control, and the ISC valve 53 is controlled to control an idling rotation speed. Upon control of the electronic throttle valve 56, the throttle actuator 54 is driven on the basis of the actual accelerator opening Acc from, for example, a relationship shown in FIG. 5, which increases the throttle opening θ_{TH} as the accelerator opening Acc increases. Further, upon starting the engine 12, a crank shaft 18 of the engine 12 is cranked by a starter (electric motor) 96.

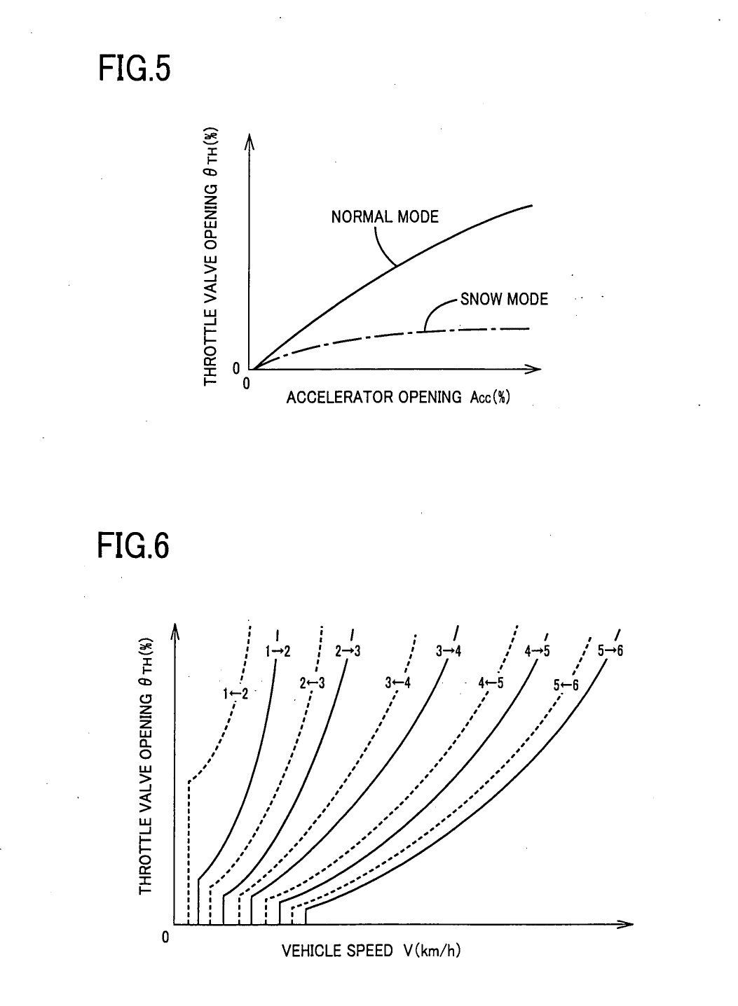

Next, the shifting control of the automatic transmission 16 will be described. A shifting diagram (shifting map) stored in advance shown in for example FIG. 6 is selected in accordance with a lever position PSH of the shift lever 72 shown in FIG. 4, and a shifting position of the automatic transmission 16 to be shifted is determined on the basis of an actual throttle opening θTH and a vehicle speed V using the shifting diagram. That is, a shifting determination from a current shifting position to a shifting position to be shifted is executed, and a shifting output to start the shifting operation to the determined shifting position is executed.

The shift lever 72, installed in the vicinity of a driver seat, is manually operated to four lever positions “R (Reverse),” “N (Neutral),” “D (Drive),” or “S (Sequential).” The “R” position is a reverse running position, the “N” position is a power transmission cutoff position, and the “D” position is a forward running position by automatic shifting. The “S” position is a forward running position where the manual shifting is possible by switching a plurality of shifting ranges having different shifting positions at a high-speed side. It is detected by the lever position sensor 74 which lever position the shift lever 72 is operated to.

Further, the lever positions “R,” “N,” and “D (S)” are provided along a longitudinal (front-rear) direction of the vehicle (upper side in FIG. 4 corresponds to front side of vehicle). By mechanically operating the manual valve coupled to the shift lever 72 via a cable, a link, or the like in accordance with a longitudinal operation of the shift lever 72, the hydraulic circuit is switched. A reverse-circuit is mechanically established at the “R” position, and the like, which establishes the reverse shifting position “Rev” shown in FIG. 2. A neutral circuit is mechanically established at the “N” position, which releases all the clutches C and brakes B.

When the “D” position or the “S” position serving as the forward running position is selected in accordance with an operation of the shift lever 72, the forward-circuit is mechanically established by switching the hydraulic circuit by the manual valve. In accordance therewith, the vehicle can run forward while executing the shifting among the 1st shifting position “1st” to the 6-th shifting position “6th” which are the forward shifting positions. An automatic shifting mode is established by determining an operation of the shift lever 72 to the “D” position on the basis of a signal of the lever position sensor 74, and the shifting control is executed using all the forward shifting positions of the “1st” shifting position “1st” to 6-th shifting position “6th.”

That is, excitation and non-excitation of the solenoid-operated valves Sol1 to Sol5 and that of the linear solenoid-operated valves SL1 and SL2 are respectively controlled not to cause a shifting shock such as a change in drive force and not to deteriorate the durability of friction materials. In accordance therewith, any one of the forward shifting positions of the “1st” shifting position “1st” to the 6-th shifting position “6th” by switching the hydraulic control circuit 98.

Reference numerals “1” to “6” in FIG. 6 respectively denote the “1st” shifting position “1st” to the 6-th shifting position “6th.” The solid lines denote shift-up lines, and the broken lines denote shift-down lines. As reduction of the vehicle speed V or increase of the throttle valve opening θ_{TH}, the shifting position is switched to the shifting position at the lower-speed side having the high gear ratio (=input rotation speed NIN/output rotation speed NOUT). Note that the 1st shifting position “1st” to the 4-th shifting position “4th” are established by the engagements of the one-way clutches F0 to F3. Therefore, upon deceleration running of the vehicle, to avoid a neutral state and to obtain an engine braking effect, the clutches C or the brakes B corresponding to “(∘)” shown in FIG. 2 are engaged.

Obtaining the engine braking effect upon deceleration running of the vehicle enhances the brake force of the vehicle. On the other hand, the driving wheels (not shown) and the input shaft 22 are separated from each other in the neutral state, the engine rotation speed NE is not temporarily reduced with the turbine rotational speed NT. In this way, a fuel cut state by a fuel cut device is continued as long as possible, which renders a fuel-economy effect by cutting fuel supply.

Operation of the shift lever 72 to the “S” position is detected by a signal of the lever position sensor 74, to establish the manual shifting mode. The “S” position is disposed adjacent to the width or lateral direction of the vehicle at the position the same as the “D” position in the longitudinal direction of the vehicle. The operation of the hydraulic circuit at the “S” position of the shift lever 72 is the same as that at the “D” position thereof. However, the manual shifting mode is electrically established, which can optionally selects a plurality of shifting ranges determined within the shifting ranges which can be shifted at the “D” position, that is, among the 1st shifting position “1st” to the 6-th shifting position “6th”.

At the “S” position, a shift-up position “(+)” and a shift-down position “(−)” are provided spaced in the longitudinal direction of the vehicle. Operation of the shift lever 72 to the shift-up position “(+)” or the shift-down position “(−)” is respectively detected by the shift-up switch 80 and the shift-down switch 82. In accordance with an range-up command RUP or a range-down command RDN, one of the six shifting ranges “D,” “5,” “4,” “3,” “2,” and “L” each having different shifting area at the maximum shifting position, that is, at the high-speed side with the low gear ratio electrically established. Within each shifting area, the shifting control is automatically performed in accordance with the shifting map of, for example, FIG. 6.

The shift lever 72 is unstable both in the shift-up position “(+)” and the shift-down position “(−)”, and is automatically returned to the “S” position by a biasing means such as a spring. Accordingly, a shifting range is changed in accordance with a number of operations to the shift-up position “(+)” or the shift-down position “(−),” or a holding time thereof.

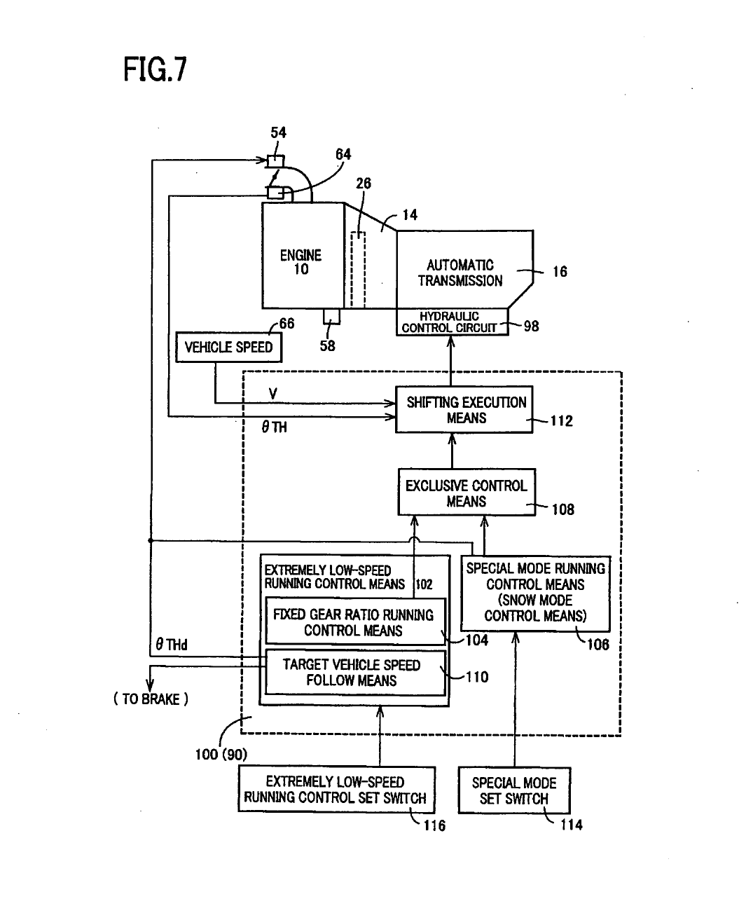

FIG. 7 is a block diagram for describing a control system of the electronic control device 90 provided to the vehicle to control the engine 10, the automatic transmission 16, and the like in FIG. 1 and FIG. 2. In FIG. 7, an extremely low-speed running control set switch 116 is provided in the vicinity of the driver seat as a dial switch, for example, as shown in FIG. 9. It can select the extremely low-speed running control and the setting a target vehicle speed VM upon the extremely low-speed running control. Information set by the extremely low-speed running control set switch 116 is transmitted to an extremely low-speed running control means 102, to be used for determining the presence or absence of an operation of the extremely low-speed running control means 102 and the like.

The extremely low-speed running control means 102 functions as a fixed gear ratio running control means. For example, the extremely low-speed running control means 102 operates when the extremely low-speed running control starting conditions are satisfied. That is, the extremely low-speed running control is selected by the extremely low-speed running control set switch 116, the vehicle is in a stopped state, the shift lever 72 is positioned at the “D” position, and the automatic transmission 16 is at the 1st shifting position, and the like. The extremely low-speed running control means 102 fixes the automatic transmission 16 to the 1st shifting position, and controls the throttle actuator 54. The throttle actuator 54 is controlled to adjust the throttle opening θ_{TH} to make an actual vehicle speed V (km/h) follow the target vehicle speed VM (km/h) which is an extremely low-speed of 1 kilometers to 5 kilometers per hour set in advance by the driver. Further, the extremely low-speed running control means 102 controls the brakes provided for the wheels to generate the brake force.

The extremely low-speed running control executed in this way is preferably used when the vehicle runs on a rough road such as a rocky road.

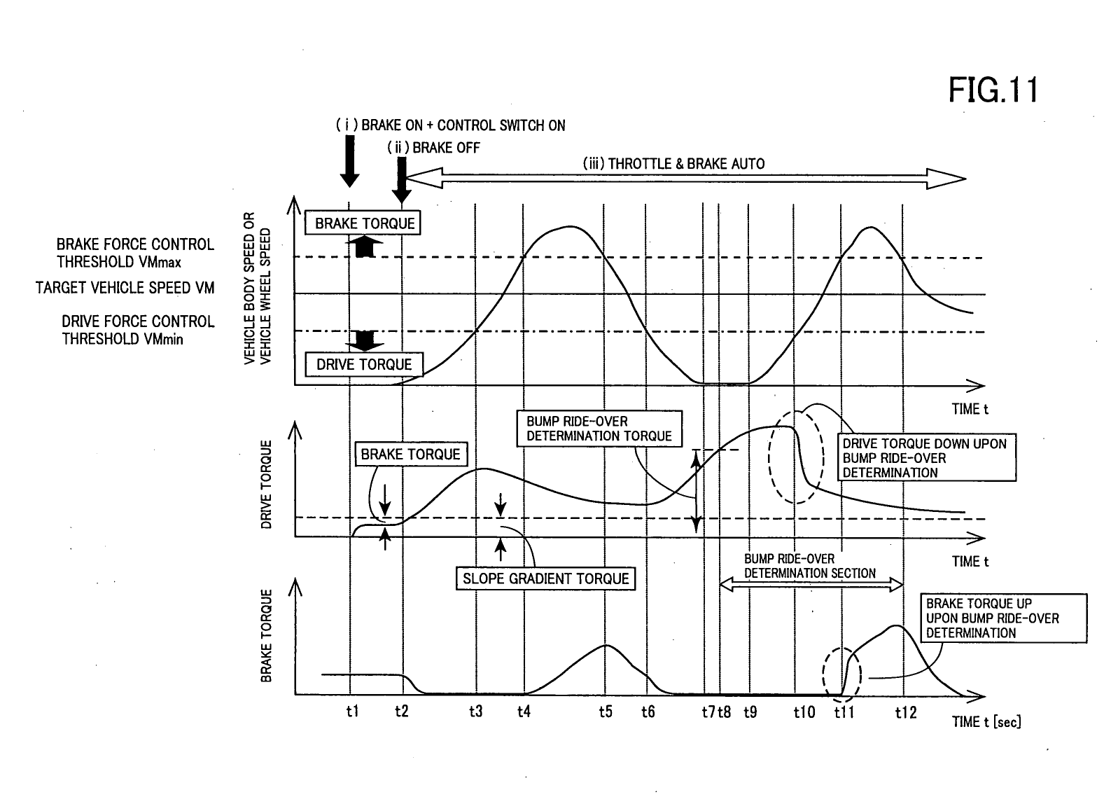

The extremely low-speed running control means 102 includes a fixed gear ratio running control means 104, and a target vehicle speed following means 110 to control the throttle and the brakes of the respective wheels so that an actual vehicle speed V follows a target vehicle speed VM. The target vehicle speed following means 110 adjusts a throttle opening θ_{TH} and a brake force by the brakes so that a vehicle speed reaches a target vehicle speed set by the driver using the extremely low-speed running control set switch 116 which will be described later. Here, the throttle opening θ_{TH} and the brake force by the brakes is, for example as shown in FIG. 11, determined by feedback control according to a deviation between the vehicle speed and the target vehicle speed.

When the aforementioned extremely low-speed running control starting conditions are established, the fixed gear ratio running control means 104 in FIG. 7 fixes the shifting position in the 1st shifting position at the minimum speed side predetermined in advance for the automatic transmission 16 to have the maximum gear ratio.

FIG. 11 shows a set of time charts for describing state of operations of the extremely low-speed running control. A vehicle body speed or a vehicle wheel speed, drive torque, and brake torque are respectively shown on the respective ordinates along with a plurality of abscissas showing common times. Among those, on a plane with a coordinate system at an upper stage on which the vehicle body speed or the vehicle wheel speed is taken on the ordinates, a brake force control threshold value Amax is shown by a broken line. This threshold value serves as a value of the vehicle body speed or the vehicle wheel speed over which the brake force control is started at a value, for example, an upper limit in the target vehicle speed area. Further, a drive force control threshold value VMmin serving as a value of the vehicle body speed or the vehicle wheel speed under which drive force control is started at a value, for example, a lower limit in the target vehicle speed area is shown by alternate long and short dashed lines. Moreover, a value of the vehicle body speed or the vehicle wheel speed corresponding to the target vehicle speed VM for the extremely low-speed running control is shown by the solid line.

Here, the brake torque applied to the vehicle by the brake control is a wheel speed feedback torque determined in accordance with a magnitude of the wheel speed higher than the upper limit value VMmax. Drive torque applied to the vehicle body by the drive force control is a total of a slope road holding torque required for stopping the vehicle on a slope road, and vehicle body speed feedback torque determined in accordance with a ratio of a vehicle body speed lower than the lower limit value VMmin. Further, when the vehicle rides over the bump, after determination of the bump ride-over, a compulsory torque-down of drive torque and compulsory torque-up of brake torque are respectively performed. This is for preventing the wheels from slipping by great torque applied to ride over the bump.

The slope road holding torque is the value determined by gradient or inclination of the slope road, a vehicle weight and the like. For example, a relationship thereof is experimentally determined and is stored in a map or the like in advance, and is appropriately read out for determining the slope road holing torque.

Time t1 in FIG. 11 denotes a state in which the vehicle is stopped by the brake operated by the driver. It is assumed that a selection switch for executing the extremely low-speed running control (extremely low-speed running set switch 116 in the present embodiment) is turned on in this state. Here, for example, when the vehicle is stopped on the slope road, the drive torque and the brake torque are respectively outputted so that the total thereof is sufficient as the slope road holding torque required for stopping the vehicle on the slope road.

At the following time t2, the brake is released by the driver. Thereafter, during a time period from t2 to t3, because the vehicle speed is lower than the lower limit value VMmin in the target vehicle speed area, the drive torque is applied to accelerate following to it. Thus, the vehicle speed is gradually increased. Then, from time t3 to time t7, the brake torque and drive torque are controlled on the basis of the vehicle body speed and the vehicle wheel speed necessary for the vehicle speed to follow the target vehicle speed.

The vehicle speed is zero at time t7. This means the vehicle is stopped resulting from that the wheels striking on or running into the bump. The drive torque is gradually increased from time t7 for the vehicle to ride over the bump, and exceeds a bump ride-over determination torque at time t8. This bump ride-over determination torque is a standard value set in advance to determine the bump ride-over when the vehicle starts by further applying drive torque, when the vehicle does not start even if the drive torque is higher than this torque.

That is, weather or not the vehicle rides over the bump is determined depending on that both conditions that the torque higher than the bump ride-over determination torque is outputted as the drive torque, and the vehicle speed changes from zero to the value greater than zero are satisfied. When the bump ride-over determination is performed, the compulsory torque-down of drive torque and the compulsory torque-up of brake torque are executed, which prevents the wheels from slipping. For this reason, when the vehicle speed is zero, even with the torque exceeding the bump ride-over determination torque, it is determined the control is still in a bump ride-over determination section for determining whether or not the vehicle rides over the bump.

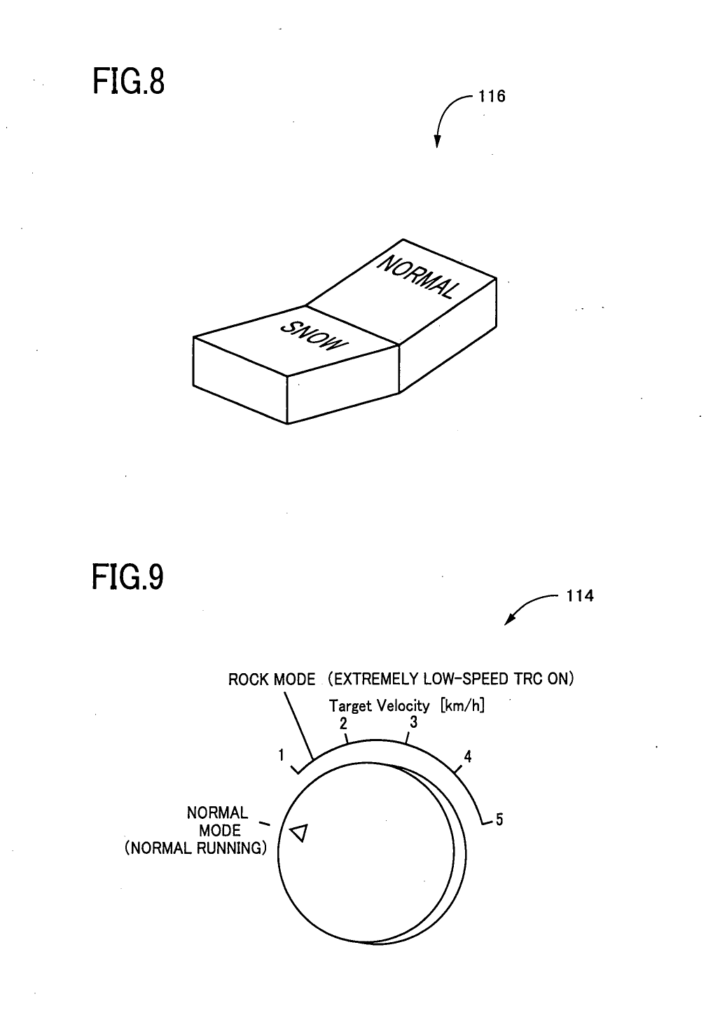

Returning to FIG. 7, a special mode set switch 114 is provided as a seesaw type switch, for example as shown in FIG. 8, in the vicinity of the driver seat. A NORMAL position for performing the normal shifting control of the automatic transmission 16, or a SNOW position for performing a snow mode is selected by the driver. The shifting control of the automatic transmission 16 is executed in a mode corresponding to the selected position.

The special mode running control means 106 executes, when the special mode set switch 114 is turned on by the driver, a special mode running in which the shifting control of the automatic transmission 16 is different from the control mode. In the present embodiment, the special mode is a snow mode, and therefore the special mode running control means 106 functions as a snow mode control means 106. The snow mode control means 106 performs the shifting, among the shifting positions of the automatic transmission 16, to prohibit switching to a predetermined lower speed shifting position having the higher gear ratio at the lower-vehicle speed side for example, the 1st shifting position fixed by the extremely low-speed running control means 102. In other words, the snow mode control means 106 executes the shifting using the shifting position higher than or equal to the second shifting position having the gear ratio lower than that of the 1st shifting position.

Further, the snow mode control means 106 not only prohibits the switching to the 1st shifting position, but also prevents increase in a slip ratio caused by an excessively large throttle opening θ_{TH}, by changing a relation of the throttle opening θ_{TH} relative to the accelerator opening Acc. To describe concretely, for example, as shown by the alternate long and short dashed line in FIG. 5, the snow mode control means 106 changes the relationship so that the throttle opening θ_{TH} becomes smaller than that in a normal mode for the same accelerator opening Acc.

An exclusive control means 108 preferentially exclusively executes one of the controls by the extremely low-speed running control means 102 and the control by the special mode running control means 106, when they are simultaneously executed. Reason is described below. As described above, the extremely low-speed running control means 102 and the special mode running control means 106 can independently start the control thereof by respectively operating the extremely low-speed running control set switch 116 and the special mode switch 114 by the driver.

However, the fixed gear ratio running control means 104 included in the extremely low-speed running control means 102 tends to fix the shifting position of the automatic transmission 16 in the 1st shifting position, and the snow mode control means 106 serving as the special mode running control means tends to execute the shifting without using the 1st shifting position among the shifting positions of the automatic transmission 16. Accordingly, the fixed gear ratio running control means 104 and the snow mode control means 106 execute the controls contradictory to each other, which cannot be simultaneously executed.

To describe concretely, for example, when the special mode switch 114 is operated by the driver to start the control by the special mode running control means 106 during the control execution by the extremely low-speed running control means 102, the execution by the extremely low-speed running control means 102 is stopped and the execution of the special mode running control means 106 is started. Further, when the extremely low-speed running control set switch 116 is operated by the driver to start the control of the extremely low-speed running control means 102 during the control execution of the special mode running control means 106, the execution of the extremely low-speed running control means 102 is not started and the execution by the special mode running control means 106 is retained.

Note that, when only one of the extremely low-speed running control means 102 and the special mode running control means 106 is executed, the execution of the one control means is sufficiently ensured. When both the control means 102 and 106 are not executed, the normal shifting control is executed.

A shifting execution means 112 executes the automatic shifting of the automatic transmission 16 by driving the solenoid-operated valves Sol1 to Sol5 and the like (refer to FIG. 3) provided on a hydraulic control circuit 66 as needed, or the like. Basically, the shifting execution means 112 executes the shifting to establish the shifting position determined using the shifting map shown in FIG. 6. However, when the control by the fixed gear ratio running control means 104 or the special mode running control means 106 is executed on the basis of a determination of the exclusive control means 108 for commanding the shifting position, the shifting execution means 112 executes the shifting to establish the commanded shifting position.

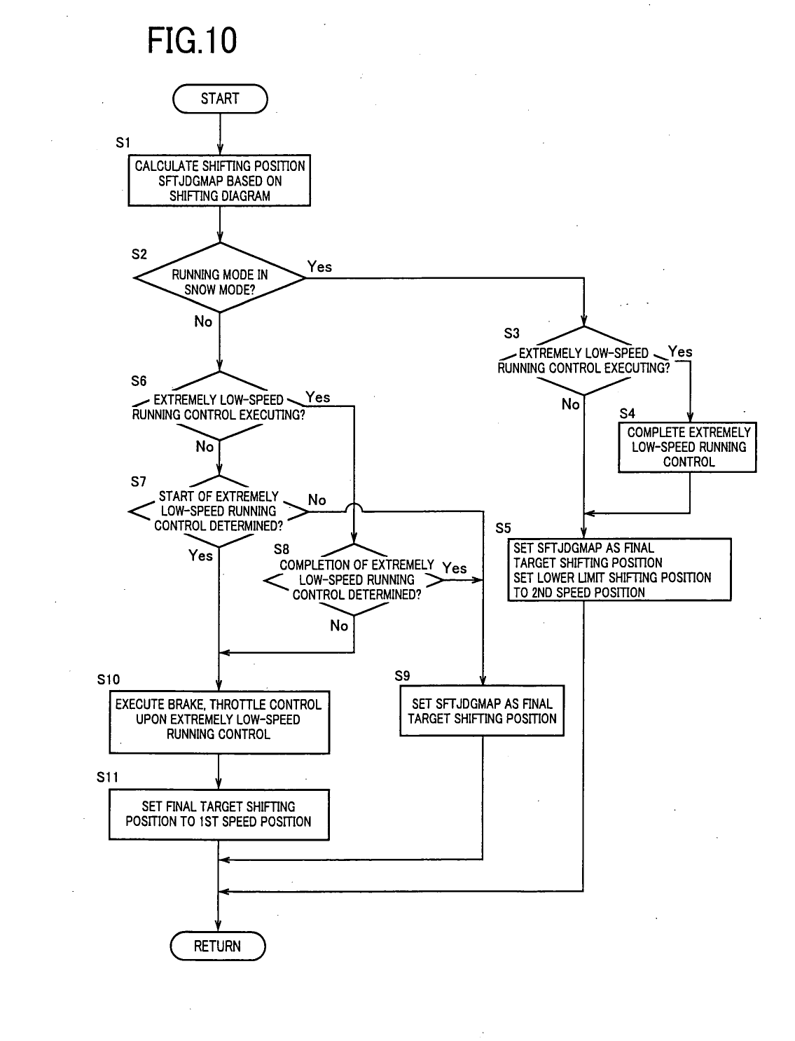

FIG. 10 is a flowchart showing principal parts of the control operations performed by the electronic control device 90, and this sequence is repeatedly executed at specified time intervals of, for example, several milli-seconds to several tens of milli-seconds. Step S1 in FIG. 10 corresponding to the shifting execution means 112, calculates a shifting position SFTJDGMAP suitable for the running in the normal shifting control using the shifting diagram shown in FIG. 6 on the basis of, for example, the vehicle speed V and the throttle opening θ_{TH}.

At step S2, for example, whether or not the control by the snow mode control means 106 is determined on the basis of turn-on or turn-off of the special mode set switch 114. When the determination at step S2 is YES, that is, when the control by the snow mode control means 106 is determined, step S3 will be next executed. On the other hand, when the determination at step S2 is NO, that is, when the control by the snow mode control means 106 is not determined, step S6 will be executed.

At step S3, for example, whether or not the control by the extremely low-speed running control means 102 is determined on the basis of turn-on or turn-off of the extremely low-speed running control set switch 116. When the determination at step S3 is NO, that is, when the control the extremely low-speed running control means 102 is not determined, it is assumed that only the snow mode control means 106 is executed, and the extremely low-speed running control means 102 is not executed, followed by execution of step S5. On the other hand, when determination at step S3 is YES, that is, when the control by both the extremely low-speed running control means 102 and the snow mode control means 106 are determined, step S4 will be executed.

Step S4 corresponding to the exclusive control means 108 completes the control by the extremely low-speed running control means 102. This is for avoiding a state in which both the extremely low-speed running control means 102 and the snow mode control means 106 interfering with one another are executed, in the control for the shifting- positions of the automatic transmission 16. In accordance therewith, the following procedure executes only the control by the snow mode control means 106,followed by step S5.

At step S5 corresponding to the snow mode control means 106, so-called snow mode control is executed. To describe concretely, among the shifting positions of the automatic transmission 16, with use of the 1st shifting position serving as the shifting position having the maximum gear ratio prohibited, the shifting is executed by use of only shifting positions higher than the second shifting position. Here, the shifting position SFTJDGMAP in the normal state of the automatic transmission 16 determined in accordance with the actual running state at step S1 is defined as the final target shifting position.

On the other hand, when the determination at step S2 is NO, step S6 to step S11 are executed. First, at step S6, for example, the execution of the extremely low-speed running control means 102 is determined on the basis of turn-on or turn-off of the extremely low-speed running control set switch 116. When the determination at step S6 is NO, that is, when both the control by the extremely low-speed running control means 102 and the snow mode control means 106 are not determined, step S7 will be executed. On the other hand, when the determination at step S6 is YES, that is, when control by the snow mode control means 106 is not determined and the control by the extremely low-speed running control means 102 is determined, step S8 will be executed.

At step S7, when the extremely low-speed running control means 102 is not being executed, it is determined whether or not the control by the extremely low-speed running control means 102 is newly started by turning on the extremely low-speed running control set switch 116. When the determination at step S7 is YES, step S10 will be executed to execute the extremely low-speed running control. On the other hand, when the determination at step S7 is NO, assuming that both the extremely low-speed running control and the snow mode control are not executed, step S9 will be executed.

Further, at step S8, when the extremely low-speed running control means 102 is being executed, whether or not completion of the execution by the extremely low-speed running control means 102 by turning off the extremely low-speed running control set switch 116 is determined. When the determination at step S8 is YES, step S9 will be executed to complete the extremely low-speed running control. On the other hand, when the determination at step S8 is NO, step S10 is executed to execute the extremely low-speed running control continuously.

Step S10 and step S1 both corresponding to the extremely low-speed running control means 102 execute an actual extremely low-speed running control. To describe concretely, first, step S10 corresponding to the target vehicle speed following means 110 executes the control for the brake force of the brakes and the throttle opening in the extremely low-speed running control. For example, when the slip ratio of the driving wheels exceeds the predetermined slip ratio, the slip ratio of the driving wheels is lowered or lessened by enhancing the brake force of the brakes or reducing the throttle opening (closing the throttle). In addition thereto, the brake force of the brakes and the throttle opening are controlled so that the vehicle speed of the vehicle follows the target vehicle speed upon the extremely low-speed running control set by the extremely low-speed running control set switch 116 by the driver.

Step S11 corresponding to the fixed gear ratio running control means or the fixed shifting position control means 104 fixes the automatic transmission 16 of the vehicle in the predetermined shifting position upon executing the extremely low-speed running control. This is for causing the vehicle to run so that the vehicle speed follows the target vehicle speed which is the extremely low speed at the 1st shifting position having the maximum gear ratio or the like.

Step S9 is executed when the control execution by the extremely low-speed running control means 102 is not determined at step S7, and when the control completion of the extremely low-speed running control means 102 is determined at step S8. Consequently, the fixing of the shifting position of the automatic transmission 16 in the predetermined shifting position executed by the fixed gear ratio running control means 104 is completed, and the shifting position SFTJDGMAP in the normal running state calculated on the basis of the shifting diagram in FIG. 6 at step S1 is defined as the final target shifting position.

In accordance with the present embodiment, the following advantageous effects can be obtained. The snow mode control means 106 corresponding to the special mode running control means may be executed during execution of the fixed gear ratio running control by the fixed gear ratio running control means 104. In this case, the control by the special mode running control means 106 with the driver's intention on the basis of an operation of the special mode set switch 114 is exclusively executed in preference to the control by the fixed gear ratio running control means 104. As a result, the shifting control reflecting the driver's intention is executed, which prevents a feeling of sudden starting of the vehicle.

In accordance with the present embodiment, the fixed gear ratio running control means 104 fixes the gear ratio γ of the automatic transmission 16 in the maximum gear ratio, that is, the gear ratio at the low-speed side upon the extremely low-speed running. Accordingly, the drive force of the driving wheels suitable for the vehicle speed V to reach the target vehicle speed which is the extremely low speed set in advance.

The special mode running control means 106 is the snow mode control means 106 which is selected on the basis of the operation of the snow mode switch, and achieves the gear ratio lower than the first gear ratio of the automatic transmission. Accordingly, when the special mode running control means 106 is executed during control execution by the fixed gear ratio running control means 104, the control by the fixed gear ratio running control means 104 is executed preferentially. There is no case where the gear ratio γ is continued to be retained higher by the fixed gear ratio running control means 104. As a result, the feeling of sudden starting unexpected by the driver can be avoided.

In accordance with the present embodiment, the electronic control device 90 serving as the control device for the vehicle automatic transmission can respectively determine whether or not the driver intends to perform the controls by the snow mode control means 106 and the fixed gear ratio running control means 104. The determinations are performed on the basis of operations of the special mode set switch 114 serving as the snow mode determining means and the extremely low-speed running control set switch 116 serving as the fixed gear ratio running determining means.

When the control by the snow mode by the special mode set switch 114 is not determined, and the control execution of the fixed gear ratio running by the extremely low-speed running control set switch 116 is determined, the fixing of a gear ratio γ of the automatic transmission in the first gear ratio by the fixed gear ratio running control means 104 is started. In this way, the snow mode control means 106 is exclusively executed preferentially.

In accordance with the present embodiment, when the snow mode is determined by the special mode set switch 114 during control execution by the fixed gear ratio running control means 104, the control execution by the fixed gear ratio running control -means 104 is interrupted. Accordingly, the control by the snow mode control means 106 is exclusively executed in preference to the control by the fixed gear ratio running control means 104.

In the automatic transmission 16 serving as the step variable automatic transmission having a plurality of shifting positions for forward running, the use of a shifting position at the minimum vehicle speed side is prohibited during the control execution by the snow mode control means 106. Accordingly, there is no case where the starting and running is performed using the shifting position with a high gear ratio, which makes it possible to prevent the driving wheels of the vehicle from slipping upon starting and running on a low-μ road or the like.

Because the fixed gear ratio running control means 104 fixes a shifting position of the automatic transmission 16 in a shifting position at the minimum vehicle speed side, that is, a shifting position having a high gear ratio among the plurality of shifting positions for forward running of the automatic transmission 16, the drive force is ensured.

The embodiments of the present invention have been described above in detail on the basis of the drawings. However, the present invention is applied to other aspects.

For example, the automatic transmission 16 which is defined as the step variable automatic transmission in the above-described embodiment is not limited thereto, and may be, for example, a continuously variable automatic transmission having the step variable shifting mode. Further, the continuously variable transmission may be a belt type which realizes the continuously variable shifting mechanically, or may be one which realizes the continuously variable shifting electrically by the electric motor.

In the above-described embodiment, the shifting position of the automatic transmission 16 is fixed in the 1st shifting position having the maximum gear ratio by the fixed gear ratio running control means 104. However, when the automatic transmission 16 is the continuously variable type automatic transmission, the gear ratio thereof is not necessarily fixed in the maximum gear ratio, and may be sufficiently set to the maximum side.

In the above-described embodiment, the seesaw type switch is used as the special mode switch 114. However, the special mode switch 114 is not limited thereto, and may be push-button switch, two push-button switches which can be maintained in a pushed state only alternatively, a lever switch, or a slide switch. Each of the switches can be selectively switched between a continuously variable shifting running (differential state) and a step variable shifting running (non-differential state).

When the automatic transmission has the special mode corresponding to the snow mode and other special mode as the control mode, the snow mode, the normal mode serving the normal shifting control, and the other special mode may be switched by the switch. Further, in place of or in addition to the switches, those may be a device which can be selectively switched at least between the continuously variable shifting running (a differential state) and the step variable shifting running (non-differential state) in response to a voice of the driver independently of a manual operation, and/or may be a device switched by a pedal operation. Alternatively, those may be a device in which a switch provided on a screen such as a multi-information display provided to the vehicle is operated with a touch-panel or the like.

In the above-described embodiment, a rotary switch is used as the extremely low-speed running control set switch 116. However, the extremely low-speed running control set switch 116 is not limited thereto, and may be a switch capable of selectively switching between an execution state and a non-execution state of the extremely low-speed running control, and of setting the target vehicle speed during control execution of the extremely low-speed running. To describe concretely, for example, a push-button switch, two push-button switches which can be maintained in a pushed state only alternatively, a lever switch, or a slide switch can be employed.

The control execution of the extremely low-speed running control and setting of the target vehicle speed may be set by separate switches. Further, in place of or in addition to the switches, a device which is at least capable of selectively switching between the continuously variable shifting running (differential state) and the step variable shifting running (non-differential state) in response to a voice of the driver independently of a manual operation, or a device switched by a pedal operation may be employed. Alternatively, a switch provided on a screen such as a multi-information display provided to the vehicle may be operated with a touch-panel or the like.

In the present embodiment, the extremely low-speed running control means 102 has the target vehicle speed following means 110 in addition to the fixed gear ratio running control means 104. However, as long as at least the fixed gear ratio running control means 104 is provided, the certain advantageous effects of the present invention can be obtained.

What is claimed is:

1. A control device for controlling a vehicle automatic transmission, comprising:
fixed gear ratio running control means that fixes a gear ratio of the automatic transmission in a first gear ratio; and
special mode running control means that prohibits shifting to a lower vehicle speed side from a second gear ratio set in a value less than the first gear ratio,
wherein when a special mode running control is selected during execution of a fixed gear ratio running control, the special mode running control is exclusively preferentially executed.

2. The control device for the vehicle automatic transmission according to claim 1, wherein the fixed gear ratio running control means is extremely low-speed running control means that controls a drive force and a brake force of driving wheels so that an actual vehicle speed reaches an extremely low-speed target vehicle speed set in advance, and fixes the gear ratio of the automatic transmission in a gear ratio set at a maximum side.

3. The control device for the vehicle automatic transmission according to claim 1, wherein the special mode running control means is snow mode control means which is selected based on an operation of a snow mode switch, and which sets the gear ratio in the value less than the first gear ratio of the automatic transmission.

4. The control device for the vehicle automatic transmission according to claim 2, wherein the special mode running control means is snow mode control means which is selected based on an operation of a snow mode switch, and which sets the gear ratio in the value less than the first gear ratio of the automatic transmission.

5. The control device for the vehicle automatic transmission according to claim 1, further comprising snow mode determination means that determines whether or not a running mode set by a driver is a snow mode, and
fixed gear ratio running determining means that determines whether or not the fixed gear ratio running control is executed,
wherein when the snow mode is not determined by the snow mode determining means, and execution of fixed gear ratio running is determined by the fixed gear ratio running determining means, the fixed gear ratio running control means starts fixing of the gear ratio of the automatic transmission in the first gear ratio.

6. The control device for the vehicle automatic transmission according to claim 5, wherein, when the snow mode determining means determines the snow mode, the fixing of the gear ratio of the automatic transmission to the first gear ratio by the fixed gear ratio running control means is completed.

7. The control device for the vehicle automatic transmission according to claim 6, wherein the automatic transmission is a step variable automatic transmission having a plurality of forward shifting positions, and
when the snow mode determining means determines the snow mode, the snow mode control means prohibits the shifting to a shifting position at a minimum vehicle speed side among the plurality of forward shifting positions of the automatic transmission.

8. The control device for the vehicle automatic transmission according to claim 7, wherein the fixed gear ratio running control means fixes the shifting position of the automatic transmission in the shifting position at the minimum vehicle speed side among the plurality of forward shifting positions of the automatic transmission.

9. The control device for the vehicle automatic transmission according to claim 5, wherein the automatic transmission is a step variable automatic transmission having a plurality of forward shifting positions, and
when the snow mode determining means determines the snow mode, the snow mode control means prohibits the shifting to a shifting position at a minimum vehicle speed side among the plurality of forward shifting positions of the automatic transmission.

10. The control device for the vehicle automatic transmission according to claim 9, wherein the fixed gear ratio running control means fixes the shifting position of the automatic transmission in the shifting position at the minimum vehicle speed side among the plurality of forward shifting positions of the automatic transmission.
